(19) United States
(12) Patent Application Publication
(10) Pub. No.: US 2016/0276748 A1
(43) Pub. Date: Sep. 22, 2016

(54) ANTENNA APPARATUS AND METHODS FOR PROVIDING MIMO AND CARRIER AGGREGATION FOR MOBILE DEVICES

(71) Applicant: Pulse Finland OY, Kempele (FI)

(72) Inventors: Prasadh Ramachandran, Oulu (FI); Kimmo Koskiniemi, Oulu (FI); Heikki Korva, Tupos (FI); Petteri Annamaa, Oulunsalo (FI)

(21) Appl. No.: 14/660,794

(22) Filed: Mar. 17, 2015

(51) Int. Cl. H01Q 5/50; H01Q 5/20; H04L 5/00; H01Q 5/10

(52) U.S. Cl. CPC H01Q 5/50; H01Q 5/10; H01Q 5/20; H04L 5/0042

(57) ABSTRACT

Multi-element antenna apparatus for mobile devices and methods of utilizing the same. In one embodiment, the antenna apparatus includes three antenna elements configured to operate in a plurality of frequency bands. The antenna elements are to a transceiver engine of a radio frequency communications device. Two of the three antenna components are configured to operate in transmit and receive modes. The third antenna component is configured to operate in receive mode. In some embodiments of an antenna apparatus operable in a carrier aggregation communication mode, two antenna components may be electrically combined into a single antenna component. The combined antenna component, characterized by a larger dimension and a larger operating bandwidth, may be operable simultaneously in two frequency bands, thereby enabling the carrier aggregation intra-band communication.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### 1. TECHNOLOGICAL FIELD

The present disclosure relates generally to antenna apparatus for use in electronic devices such as wireless or portable radio devices, and more particularly in one exemplary aspect to MIMO and carrier aggregation antenna apparatus and methods of using the same.

### 2. DESCRIPTION OF RELATED TECHNOLOGY

Internal antennas are commonly found in most modern radio devices, such as mobile computers, tablets, mobile phones, Blackberry® devices, smartphones, personal digital assistants (PDAs), or other personal communication devices (PCD). Typically, these antennas comprise a planar radiating plane and a ground plane parallel thereto, which are connected to each other by a short-circuit conductor in order to achieve the matching of the antenna. The structure is configured such that it functions as a resonator at the desired operating frequency. It is also a common requirement that the antenna operate in more than one frequency band (such as dual-band, tri-band, or quad-band mobile phones), in which case two or more resonators are used.

Due to an increasing demand for mobile data, portable communication devices often require operation at ever increasing data rates. To achieve these increasing data rates it is necessary to increase the transmission bandwidths over those that can be supported by a single carrier or channel. Some wireless communications standards (e.g., Long Term Evolution LTE-Advanced (LTE-A)) enable operation of mobile devices in a carrier aggregation (CA) mode, wherein two or more component carriers (e.g., channels with individual bandwidths of up to 20 MHz) may be combined into a single virtual channel of an increased bandwidth thereby increasing maximum available data rate for mobile radio transmissions. Simultaneous operation on multiple channels may require placement of multiple antennas within a mobile device. At the same time users often prefer slimmer and/or smaller devices that may limit internal volume available for placement of internal antennas.

Accordingly, there is a salient need for a wireless solution for e.g., a portable radio device with a small form factor body and/or chassis that offers lower cost and complexity over prior art designs, and provides for space-efficient antenna apparatus implementations supporting simultaneous operation at multiple frequency bands, and methods for using the same.

### SUMMARY

The present disclosure satisfies the foregoing needs by providing, inter alia, improved antenna apparatus for use in electronic devices such as wireless or portable radio devices, and more particularly in one exemplary aspect to MIMO and carrier aggregation antenna apparatus and methods of using the same.

In a first aspect, an antenna apparatus is disclosed. In one embodiment, the antenna apparatus includes: first, second and third radiator elements; a tuning component configured to tune individual ones of the first, second and third radiator elements operate in a respective frequency band; and a switching component configured to electrically combine the first and the second antenna radiator elements to produce a combined radiator component; the first and the second antenna radiator elements are configured to operate using a first and a second carrier characterized by first and second bandwidth; the combined radiator component is configured to perform communication using a third radio frequency carrier characterized by third bandwidth; and the third bandwidth comprises a sum of the first and the second bandwidths.

In one variant, the tuning component is configured to tune the first and the second radiator elements to operate in a first frequency band; and the first and the second carrier are configured within the first frequency band.

In another variant, the respective frequency band comprises one of a lower frequency band selected in a range between 600 MHz and 960 MHz and an upper frequency band selected in a range between 1700 MHz and 2700 MHz; and the first frequency band comprises one of the lower or upper frequency band.

In another variant, the first bandwidth is configured to occupy a frequency range adjacent to frequency range corresponding to the second bandwidth so that the third bandwidth comprises a contiguous frequency range.

In yet another variant, the first bandwidth is configured to occupy a frequency range spaced apart from frequency range corresponding to the second bandwidth so that the third bandwidth comprises a frequency range comprising a gap of frequency that is unused by the combined radiator component.

In another variant, the tuning component configured to tune the first radiator elements to operate in a first frequency band and the second radiator elements to operate in a second frequency band; and operation of the combined radiator component comprises receiving radio waves in the first frequency band contemporaneous with receiving radio waves in the second frequency band; the receiving the radio waves in the first frequency band is effectuated by the first radiator element; and the receiving the radio waves in the second frequency band is effectuated by the second radiator element.

In a second aspect, a mobile wireless communications device is disclosed. In one embodiment, the mobile wireless device includes: a transceiver component; a multi-element antenna apparatus operably coupled to the transceiver; and a logic component coupled to the transceiver, the logic component operable to: detect interference associated with communicating data via a first antenna element of the multi-element antenna apparatus; and direct the transceiver to switch the communication to a second antenna element of the multi-element antenna apparatus; the first antenna element is configured to transmit and receive data at a first carrier within a frequency band; and the second antenna element is configured only to receive data at the first carrier.

In one variant, the mobile communications device includes: an electronics board comprising the logic component; and an enclosure housing the electronics board and the transceiver component; the enclosure is characterized by a rectangular shape comprising a top edge and a bottom edge; and the interference determination is configured based on analysis of strength of signal received by the first antenna element at the first carrier.

In another variant, the first and the second antenna elements are disposed proximate the bottom edge; and the third antenna elements is disposed proximate the top edge, the disposition proximity being configured based on a distance between a most proximate point of a given antenna elements to a respective edge being smaller than lateral extent of the given antenna elements.

In a third aspect, a method for configuring an antenna apparatus of a mobile wireless device to communicate in a carrier aggregation mode is disclosed. In one embodiment, the method includes configuring a first, a second and a third antenna elements to operate in a first or a second frequency bands, frequencies within the first frequency band being separated from frequencies within the second frequency band by a range of frequencies at least the first bandwidth of the first band; coupling individual ones of the first, second and third antenna elements to a switching component; configuring the switching component to electrically combine the first and the second antenna elements to produce a combined component; the first and the second antenna radiator elements are configured to operate using a first and a second carrier characterized by first and second bandwidth; the combined radiator component is configured to perform communication using a third radio frequency carrier characterized by third bandwidth; and the third bandwidth comprises a sum of the first and the second bandwidths.

In one variant, the act of combining is configured to occur based on a receipt of an indication by the mobile device for operation in a carrier aggregation mode; and the carrier aggregation mode comprises an intra-band carrier aggregation mode configured to place the first and the second carrier into a given band of the a first or a second frequency bands.

In another variant, the intra-band aggregation mode comprises a contiguous carrier aggregation model; and the first bandwidth is configured to occupy a frequency range adjacent to frequency range corresponding to the second bandwidth so that the third bandwidth comprises a contiguous frequency range.

In another variant, the intra-band aggregation mode comprises a non-contiguous carrier aggregation model; and the first bandwidth is configured to occupy a frequency range spaced from frequency range corresponding to the second bandwidth.

In another variant, the combined antenna component is configured to communicate via first carrier and the second carrier information related to a data session associated with the mobile device; and the third antenna element is configured to communicate, via a third carrier, information related to a voice session associated with the mobile device, the voice information communication configured to occur contemporaneous with the data information communication.

In a further variant, the first antenna element is configured to operate in the first frequency band; the second antenna element is configured to operate in the second frequency band, the second frequency band being spaced from the first frequency band by at least half of frequency extent of the first frequency band; and the carrier aggregation mode comprises an inter-band carrier aggregation mode configured to place the first carrier into one of the first or the second frequency bands and the second carrier into the other one of the first or the second frequency bands.

In yet another variant, the first carrier is configured to communicate information related to a data session associated with the mobile device; and the second carrier is configured to communicate information related to a voice session associated with the mobile device, the voice information communication configured to occur contemporaneous with the data information communication.

In a fourth aspect, a method for configuring a mobile wireless device is disclosed.

Further features of the present disclosure, its nature and various advantages will be more apparent from the accompanying drawings and the following detailed description.

### BRIEF DESCRIPTION OF THE DRAWINGS

The features, objectives, and advantages of the disclosure will become more apparent from the detailed description set forth below when taken in conjunction with the drawings, wherein:

FIG. 1A is functional block diagram illustrating a multi-element antenna apparatus comprising a plurality of antenna components and switching elements configured in accordance with the principles of the present disclosure.

FIG. 1B is functional block diagram illustrating a generalized configuration of a multi-element antenna apparatus for providing communication using spatial multiplexing and/or carrier aggregation in accordance with the principles of the present disclosure.

FIG. 2A is functional block diagram illustrating a multi-element antenna apparatus configured for intra-band carrier aggregation (CA) and 2×2 MIMO communication in accordance with the principles of the present disclosure.

FIG. 2B is functional block diagram illustrating a multi-element antenna apparatus configured for inter-band carrier aggregation and/or MIMO communication in accordance with the principles of the present disclosure.

FIGS. 3A-3B are functional block diagrams illustrating a multi-element antenna apparatus configured to mitigate communication interference during hand held operation of a mobile communications device in accordance with the principles of the present disclosure.

FIG. 4 is functional block diagrams illustrating a multi-element antenna apparatus configured to provide simultaneous voice data communication for a mobile communications device in accordance with the principles of the present disclosure.

FIG. 5 is a graphical illustration of hand-held operation of a mobile communication apparatus comprising a multi-element antenna apparatus in accordance with the principles of the present disclosure.

FIG. 6 is a functional block diagram illustrating a mobile communications device for use with a multiband antenna apparatus configured in accordance with in accordance with the principles of the present disclosure.

FIG. 7 is a logical flow diagram illustrating a method of using a multi-element antenna apparatus for carrier aggregation operation in a mobile communications device in accordance with the principles of the present disclosure.

FIG. 8 is a logical flow diagram illustrating one embodiment of a method of operating a multi-element antenna apparatus in accordance with the principles of the present disclosure.

All Figures disclosed herein are © Copyright 2014-15 Pulse Finland Oy. All rights reserved.

### DETAILED DESCRIPTION

Reference is now made to the drawings, wherein like numerals refer to like parts throughout.

As used herein, the terms “antenna,” “antenna system,” “antenna assembly”, and “multiband antenna” refer without limitation to any system that incorporates a single element, multiple elements, or one or more arrays of elements that receive/transmit and/or propagate one or more frequency bands of electromagnetic radiation. The radiation may be of numerous types including, e.g., microwave, millimeter wave, radio frequency, digital modulated, analog, analog/digital encoded, digitally encoded millimeter wave energy, or the like. The energy may be transmitted from one location to another location, using, one or more repeater links, and one or more locations may be mobile, stationary, or fixed relative to a location on earth such as a base station.

As used herein, the terms “board” and “substrate” refer generally and without limitation to any substantially planar or curved surface or component upon which other components can be disposed. For example, a substrate may comprise a single or multi-layered printed circuit board (e.g., FR4), a semi-conductive die or wafer, or even a surface of a housing or other device component, and may be substantially rigid or alternatively at least somewhat flexible.

As used herein, the terms “electrical component” and “electronic component” are used interchangeably and refer to components adapted to provide some electrical and/or signal conditioning function, including without limitation inductive reactors (“choke coils”), transformers, filters, transistors, gapped core toroids, inductors (coupled or otherwise), capacitors, resistors, operational amplifiers, and diodes, whether discrete components or integrated circuits, whether alone or in combination.

The terms “frequency range”, “frequency band”, and “frequency domain” refer without limitation to any frequency range for communicating signals. Such signals may be communicated pursuant to one or more standards or wireless air interfaces.

Furthermore, as used herein, the terms “radiator,” “radiating plane,” and “radiating element” refer without limitation to an element that can function as part of a system that receives and/or transmits radio-frequency electromagnetic radiation; e.g., an antenna.

The terms “RF feed,” “feed,” “feed conductor,” and “feed network” refer without limitation to any energy conductor and coupling element(s) that can transfer energy, transform impedance, enhance performance characteristics, and conform impedance properties between an incoming/outgoing RF energy signals to that of one or more connective elements, such as for example a radiator.

As used herein, the terms “top”, “bottom”, “side”, “up”, “down”, “left”, “right”, and the like merely connote a relative position or geometry of one component to another, and in no way connote an absolute frame of reference or any required orientation. For example, a “top” portion of a component may actually reside below a “bottom” portion when the component is mounted to another device (e.g., to the underside of a PCB).

As used herein, the term “wireless” means any wireless signal, data, communication, or other interface including without limitation Wi-Fi, Bluetooth, 3G 3GPP, 3GPP2, and UMTS), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, Long Term Evolution (LTE) or LTE-Advanced (LTE-A), analog cellular, CDPD, satellite systems such as GPS, millimeter wave or microwave systems, optical, acoustic, and infrared (i.e., IrDA).

It is recognized that the antenna embodiments discussed herein may be readily manufactured using a variety of known methods including, for example: (1) flexible substrates such as that disclosed in co-owned and co-pending U.S. patent application Ser. No. 13/835,129 entitled “Flexible Substrate Inductive Apparatus and Methods” filed Mar. 15, 2013, and co-owned and co-pending U.S. patent application Ser. No. 13/801,967 entitled “Flexible Substrate Inductive Apparatus and Methods” filed Mar. 13, 2013, each of the foregoing being incorporated herein by reference in its entirety; (2) sheet metal fabrication techniques; (3) fluid or vapor deposition; (4) “2-shot” molding; (5) pad printing; (6) print deposition such as that disclosed in co-owned and co-pending U.S. patent application Ser. No. 13/782,993 entitled “Deposition Antenna Apparatus and Methods” filed Mar. 1, 2013, co-owned and co-pending U.S. patent application Ser. No. 14/620,108 entitled “Methods and Apparatus for Conductive Element Deposition and Formation” filed Feb. 11, 2015, and co-owned and co-pending U.S. Provisional Patent Application Ser. No. 62/026,560 entitled “Methods and Apparatus for Conductive Element Deposition and Formation” filed Jul. 18, 2014, each of the foregoing being incorporated herein by reference in its entirety; and/or (7) laser direct structuring (LDS) as applicable such as that disclosed in co-owned and co-pending U.S. patent application Ser. No. 12/482,371 entitled “Miniaturized Connectors and Methods” filed Jun. 10, 2009, which is incorporated herein by reference in its entirety, such techniques and structures being readily determined by those of ordinary skill when given the present disclosure.

### OVERVIEW

In one salient aspect, the present disclosure provides improved portable communications antenna apparatus and methods of using the same. In one embodiment, the antenna apparatus comprises three antenna elements (A, B, C) configured to operate in three frequency bands. Individual ones of the antenna elements A, B, C may also include a switch, a tuning circuit and/or other electronic components.

In some implementations using LTE and/or LTE-A antenna apparatus, individual frequency bands may comprise: a lower band (LB) covering a frequency range from 600 MHz to 960 MHz, a middle band (MB) covering a frequency range from 1710 MHz to 2170 MHz; and an upper band (UB) covering a frequency range from 2300 MHz to 2690 MHz. In one variant, the MB and the UB may be combined into one band covering frequencies from 1710 MHz to 2790 MHz. The antenna elements A, B, C are coupled to a transceiver engine of a radio frequency communications device (e.g., a smartphone). Two of the three antenna components (e.g., antenna A and antenna B) may be configured to operate in transmit (Tx) and receive (Rx) modes, whereas antenna component C may be configured to operate in a receive (Rx) mode.

In some embodiments, the antenna apparatus is operable in a carrier aggregation (CA) communication mode; antenna components (e.g., antenna A and antenna B) may be combined electrically so as to form a single antenna component. The combined antenna component, characterized by a larger dimension and a larger operating bandwidth, may be operable simultaneously in two frequency bands F1, F2 thereby enabling the CA intra-band communication. In some embodiments of an intra-band CA antenna apparatus operable in the 2×2 multiple-input-multiple-output (MIMO) mode, the antenna component C may be used to provide a second receive path and may be operable in frequency band F1, frequency band F2 or a combined frequency band F1 and F2, in addition to the receive path of the combined antenna components A+B. In an inter-band downlink MIMO CA, the antenna components A, C may be configured to cover two individual receive bands (Rx1, Rx2); while the antenna component B may form the MIMO receive path in one of the bands (Rx1 or Rx2). When operating in the inter-band CA mode, two (or more) transceivers are required to be operable contemporaneously with one another. Aggregation of two or more carriers may enable data transmission in parallel with one another thereby providing for an increased throughput, compared to operation using a given carrier.

Antenna configurations described herein may enable a mobile device to communicate at a higher data rate compared to existing devices due to larger bandwidth and simultaneous MIMO operation.

Moreover, in some embodiments, antenna components A and B may be switched/re-routed to mitigate attenuation and/or interference due to, for example, handheld operation by a user. Furthermore, antenna component C may be used to provide an additional receive path in order to mitigate handheld interference.

In some embodiments, selective switching/re-routing of antenna components A, B, C may facilitate a simultaneous voice and data (SVD) communication mode of operation. In one such implementation of SV-LTE, packet switched LTE services may run simultaneously with a circuit switched voice service. SV-LTE facility provides the facilities of circuit-switched fallback (CSFB) at the same time as running a packet switched data service. In order to enable SVD functionality, two radios are required to operate simultaneously over two individual antennas. By way of an illustration of one exemplary embodiment of SVD communication, antenna component A may be used to carry a data portion while antenna component B may be used to carry the voice portion of the communication, thereby enabling the mobile communications device of the disclosure to provide data service during a voice call.

### DETAILED DESCRIPTION OF EXEMPLARY EMBODIMENTS

Detailed descriptions of the various embodiments and variants of the apparatus and methods of the present disclosure are now provided. While primarily discussed in the context of mobile devices, the various apparatus and methodologies discussed herein are not so limited. In fact, many of the apparatus and methodologies described herein are useful in any number of complex antennas, whether associated with mobile or fixed devices that can benefit from the methodologies and apparatus described herein.

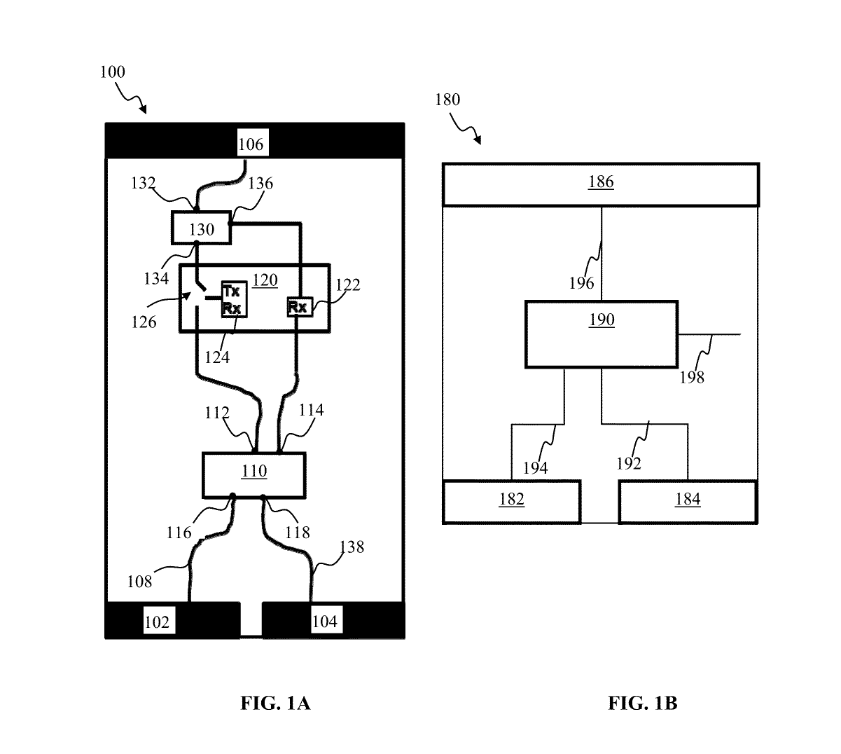

FIG. 1A illustrates one embodiment of a multi-element antenna apparatus 100 comprising three antenna components and two switching components. The antenna apparatus may be disposed in a radio frequency communications device (e.g., a smartphone, a tablet computer, a phablet, and/or other wireless communications device). In the illustrated embodiment, the antenna apparatus includes antenna elements 102, 104, 106, a double-pole double-throw (DPDT) switch component 110, a transceiver engine 120, and a single-pole double-throw (SPDT) switch component 130. The illustrated switch component 110 includes four ports 112, 114, 116, 118. Furthermore, illustrated switch component 130 includes three ports 132, 134, 136. Moreover, two or more ports of illustrated switch components 110, 130 may be coupled to one another as described below with respect to Table 1. While FIG. 1A illustrates a particular implementation with three antenna elements additional antenna element solutions are readily envisioned along with associated switching components and ports. For example, in 4×4 MIMO implementations with CA, six antenna elements are required.

The antenna elements 102, 104, 106 are configured to operate in a plurality of frequency bands, e.g., the UB, LB, and/or MB described below with respect to FIG. 1A. However, it will be appreciated by those skilled in the arts that the antenna apparatus of the present disclosure may be configured to operate in a variety of frequency bands configured in accordance with a particular application.

The transceiver engine 120 in the illustrated embodiment includes a transmit-receive (transceiver) component 124 and a receive-only (receiver) component 122. Components 122, 124 may be operable in one or more of the frequency bands described above (e.g., LB, MB, and UB) and/or other bands. In some implementations configured to support MIMO, the components 122, 124 may be configured to operate contemporaneous with one another thereby enabling two individual receive (MI) paths.

The antenna elements 102, 104, 106 are, in the illustrated embodiment, coupled to a transceiver engine of a radio frequency communications device (e.g., a smartphone). Two of the three antenna elements (e.g., component 102, 104) are configured to operate in transmit (Tx) and receive (Rx) modes. Transmit/receive operations can be multiplexed via a transmit-receive switch component 126 configured to alternately couple a given antenna element (e.g., 102, 104) to transmit or receive ports of the transceiver component 124; or the antenna element 106 via the receive port of the receiver component 126. Hence, antenna element 106 may be configured to operate in a receive (Rx) only mode. Alternatively, the antenna element 106 may be configured to operate in transmit/receive Tx/Rx mode.

In some implementations of carrier aggregation (CA), the switching component 110 may be used to electrically combine antenna elements 102, 104 in order to obtain an electrically larger antenna so as to produce a combined antenna element characterized by an increased operational bandwidth (as compared with individual antenna elements 102 or 104).

Antenna elements 102, 104 are illustrated as being coupled to the switching component 110 via delay line components 108, 138, respectively. Delay values for the components 108, 138 may be selected such that signals associated with the antenna element 104 are combined constructively with signals associated with the antenna element 102 thereby producing a signal as would be obtained using a single antenna element.

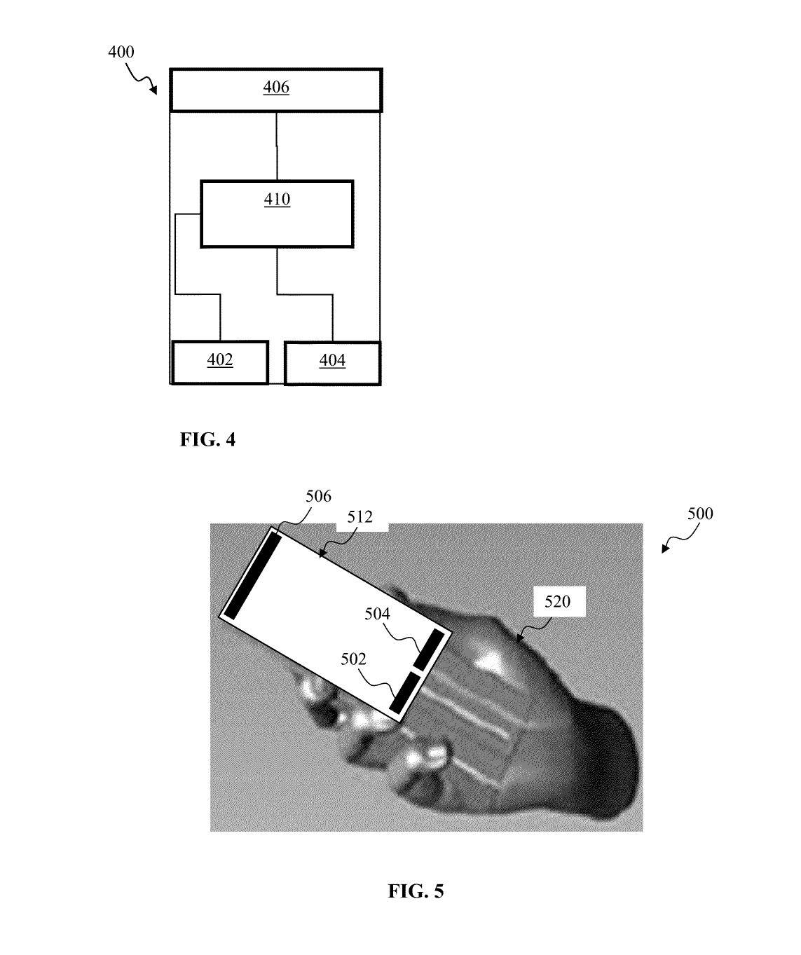

The antenna apparatus 100 may be embodied in a portable communications device (e.g., a smartphone, a tablet computer, a phablet, and/or other device). When operated in a hand-held mode, interference may arise due to proximity of a user's hand. FIG. 5 illustrates one hand-held operational configuration 500 of a portable communications device 512. Proximity of a user's hand 520 (and/or head, not shown) may attenuate and/or interfere with radio transmissions and/or reception by one or more antenna elements 502, 504, 506 of the mobile device 512. The device 512 may comprise a processing component configured to detect interference and switch over communication from one antenna component (e.g., 504 in FIG. 5) to another antenna component (e.g., 502 and/or 506) thereby reducing potential data loss, improving communication robustness and/or user experience.

Returning now to FIG. 1A, in some implementations of MIMO communication, the switching component 130 may be used to couple antenna element 106 to the receive port of the transceiver engine 120 (via e.g., transceiver 124 or receiver component 122) thereby providing an additional receive communication path. In some implementations of simultaneous voice and data communication, coupling of the antenna element 106 via the switching component 130 may be used to provide a receive path for data or for voice in addition to another receive path associated with antenna elements 102 and/or 104 that may be utilized used for voice/data, respectively.

Moreover, in alternative implementations for hand-held interference mitigation, the coupling of the antenna element 106, via the switching component 130, to the transceiver engine 120 may be used switch over receive path from another antenna element (e.g., 102 and/or 104) to the antenna element 106 thereby providing uninterrupted communication by the antenna apparatus 100 in the presence of interference.

Table 1 illustrates connectivity of the antenna elements and exemplary modes of operation of the antenna apparatus 100. Switching operations described with respect to Table 1 and FIGS. 1A-1B refer to the feed connection for a respective antenna element. Ground connections (not shown in FIGS. 1A-1B) of the antenna elements 102, 104, 106 may, in an exemplary embodiment, be connected to the ground associated with the transceiver engine 120 and may remain not switched when changing from one mode of operation to another mode of operation.

In mode I, the switching component 110 is configured to connect port 118 to port 112 and port 116 to port 112, thereby electrically coupling the antenna elements 102, 104. The switching component 130 is configured to connect port 132 to port 136 thereby providing another receive path for communication (in addition to the receive path associated with the port 112).

In mode II, the switching component 110 is configured to connect port 118 to port 114 and port 116 to port 114, thereby electrically coupling the antenna elements 102, 104. The switching component 130 is configured to connect port 132 to port 134 thereby providing another receive path for communication. Modes I and II may be referred to as intra-band carrier aggregation with 2×2 downlink MIMO spatial multiplexing. Selection of a given mode I or II for configuring the antenna apparatus 100 may be effectuated based on detected interference due to hand-effect. In some implementations of the intra-band CA of LTE bands B3 (1710 MHz to-1935 MHz) and B4 (1935 MHz to 2155 MHz), antenna element 102 may be configured to operate in band B3 while antenna element 104 may operate in band B4. Signals from antenna element 102 may be combined out of phase with signals from antenna element 104 via the switching component 110. As a result, the resultant bandwidths for the antenna elements 102, 104 may be combined and at the output of switching component 110, the antenna elements 102, 104 may be considered as a single antenna element. Antenna elements 102, 104 may be combined to cover a frequency band from 1710 MHz to 1785 MHz in Tx mode; and a frequency band from 1805 MHz to 2155 MHz in Rx mode. In some implementations of the intra-band CA, when hand effect compensation may be of use, the antenna element 106 may be configured to provide a Tx mode of operation.

In mode III, the switching component 110 is configured to connect port 116 to port 112 and port 118 to port 114, thereby enabling two simultaneous receive paths via antenna elements 102 and 104. The switching component 130 is configured to connect port 132 to port 136.

In mode IV, the switching component 110 is configured to connect port 116 to port 114 and port 118 to port 112, thereby enabling two simultaneous receive paths via antenna elements 102 and 104. The switching component 130 is configured to connect port 132 to port 136. Modes III and IV may be referred to as inter-band carrier aggregation with 2×2 downlink MIMO multiplexing. Selection of a given mode III or mode IV for configuring the antenna apparatus 100 is effectuated based on detected interference due to hand-effect.

In mode V, the switching component 110 is configured to connect port 116 to port 112 and port 118 to port 114. The switching component 130 is configured to disconnect port 132.

In mode VI, the switching component 110 is configured to connect port 116 to port 114 and port 118 to port 112. The switching component 130 is configured to disconnect port 132. In modes V, VI the antenna elements 102, 104 may be selectively coupled to the transceiver component 124 or the receiver component 122 in order to mitigate communication interference effects due to hand loading.

In mode VII, the switching component 110 is configured to connect port 116 to port 112. The switching component 130 is configured to connect port 132 to port 136.

In mode VIII, the switching component 110 is configured to connect port 118 to port 112. The switching component 130 is configured to connect port 132 to port 136. In modes VII and VIII, one of antenna elements 102 or 104 may be selectively coupled to the transceiver component 124 in order to mitigate communication interference effects due to hand loading. In some implementations wherein signal reception via the antenna element 102 or 104 may be characterized by performance that is below a threshold (e.g., RSSI 2 or 5 dB below threshold) the antenna element 106 provides a receive path in order to mitigate communication interference effects due to hand loading.

In mode IX, the switching component 110 is configured to connect port 116 to port 112. The switching component 130 is configured to connect port 132 to port 136.

In mode X, the switching component 110 is configured to connect port 118 to port 112. The switching component 130 is configured to connect port 132 to port 136. In modes IX and X, one of antenna elements 102 or 104 may be selectively coupled to the transceiver component 124. The antenna element 106 is coupled to the receiver 122 in order to provide another receive path for simultaneous voice and data (SVD) communication. In some implementations, the antenna element 102 or 104 is used to communicate the voice portion of the SVD information; the antenna component 106 is used to communicate the data portion.

TABLE 1

| | | Component 110 | Component 130 |
|---|---|---|---|
| Mode | Exemplary use | port state | port state |
| I | Intra-band CA + | 118 to 112 | 132 to 136 |
| | 2 × 2 downlink MIMO | 116 to 112 | |
| II | Intra-band CA + | 118 to 114 | 132 to 134 |
| | 2 × 2 downlink MIMO | 116 to 114 | |
| | hand effect compensation | | |
| III | Inter-band CA + | 116 to 112 | 132 to 136 |
| | 2 × 2 downlink MIMO | 118 to 114 | |
| IV | Inter-band CA + | 116 to 114 | 132 to 136 |
| | 2 × 2 downlink MIMO | 118 to 112 | |
| | hand effect compensation | | |
| | between 102 and 104 | | |
| V | Non-CA mode 1 | 116 to 112 | 132 not |
| | hand effect compensation | 118 to 114 | connected |
| | between 102 and 104 | | |
| VI | Non-CA mode 2 | 116 to 114 | 132 not |
| | hand effect compensation | 118 to 112 | connected |
| | between 104 and 102 | | |
| VII | Non-CA mode 3 | 116 to 112 | 132 to 136 |
| | hand loading | | |
| | compensation done | | |
| | between 102/104 and 106 | | |
| VIII | Non-CA mode 4 | 118 to 112 | 132 to 136 |
| | hand loading | | |
| | compensation done | | |
| | between 102/104 and 106 | | |
| IX | SVD Mode 1 | 116 to 112 | 132 to 136 |
| | | | (In the Rx Module |
| | | | internally signal is |
| | | | routed to the CDMA |
| | | | receiver) |
| X | SVD Mode 2 | 118 to 112 | 132 to 136 |

FIG. 1B illustrates a generalized configuration of a multi-element antenna apparatus 180 for providing communication using spatial multiplexing and/or carrier aggregation in accordance with one or more implementations.

The illustrated antenna apparatus 180 includes a plurality of antenna elements (e.g., antenna elements 182, 184, and 186 similar to that shown in FIG. 1A, and/or other antenna elements (not shown) via the pathway 198. Antenna elements 182, 184, and 186 may also be referred to as radiators in some implementations. The antenna apparatus 180 includes a transmit/receive electronics engine 190 coupled to the antenna elements via pathways 192, 194, 196, and 198. In one or more implementations, the transmit/receive electronics engine 190 includes switching components configured to selectively couple/decouple a given antenna element (e.g., 182, 184, 186). In some implementations, the switching mechanisms may be embodied with a respective antenna element.

In one or more implementations, individual antenna elements 182, 184, 186 may comprise a planar antenna element (e.g., a planar inverted F antenna (PIFA), and/or a planar inverted L antenna), a chip antenna element, a loop antenna, a slot antenna, monopole antenna.

The antenna elements 182, 184, 186 may be configured to operate in a plurality of frequency bands. In some implementations, size and/or electrical characteristics of the antenna elements 182, 184, and 186 may be designed to support operation in a lower band (LB) covering a frequency range from 600 MHz to 960 MHz, a middle band (MB) covering a frequency range from 1710 MHz to 2170 MHz; and an upper band (UB) covering a frequency range from 2300 MHz to 2690 MHz. In one variant, the MB and the UB may be combined into one band covering frequencies from 1710 MHz to 2790 MHz. Individual antenna elements (e.g., 182, 184, 186) may include tuning electronics configured to tune a given element to one or more frequency bands. It will be appreciated by those skilled in the arts that the antenna apparatus of the present disclosure may be configured to operate in a variety of differing frequency bands configured in accordance with a particular application. Moreover, selective coupling/decoupling of one or more antenna elements 182, 184, 186 to the transmit/receive electronics engine 190 may enable the antenna apparatus 180 to provide flexible modes of communication for a mobile communication device such as, e.g., carrier aggregation, MIMO, SVD, interference mitigation, and/or other modes of communication.

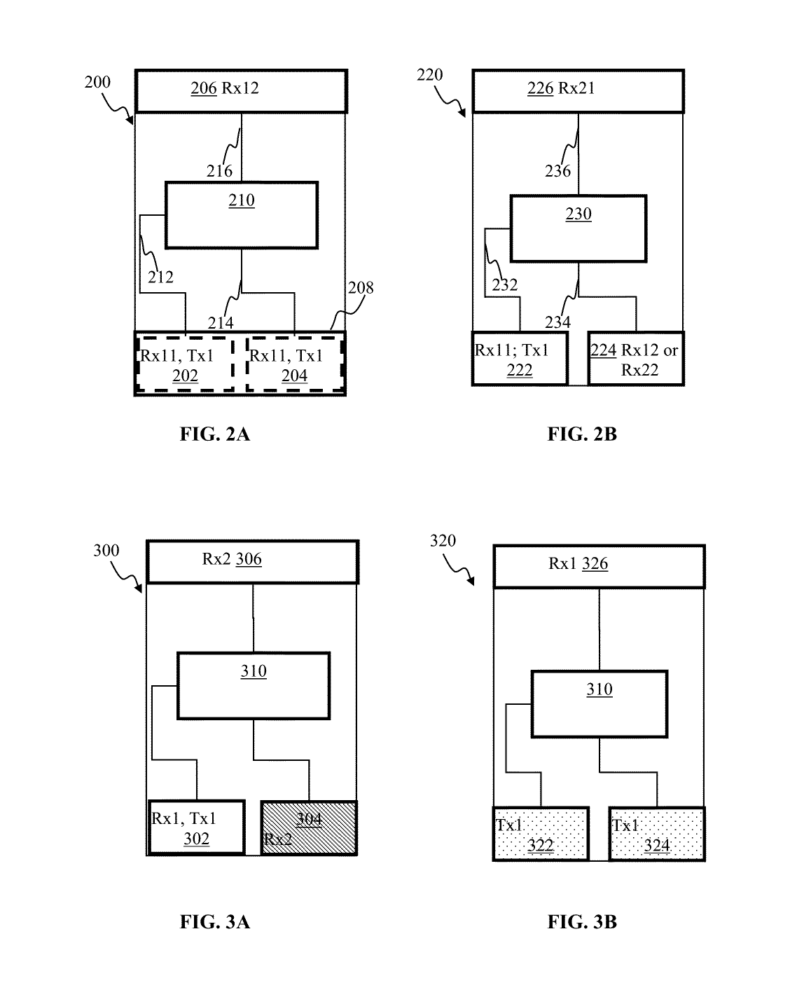

FIG. 2A illustrates a multi-element antenna apparatus 200 (e.g., similar to FIG. 1A) configured for intra-band CA and 2×2 MIMO communication in accordance with one implementation.

As used herein, the term intra-band CA may be used to describe configuring two LTE carriers (e.g., two Physical Uplink Shared Channels (PUSCH)) within a single LTE transmission band. A given PUSCH is typically shared by one or more devices (user equipment (UE)) in a radio cell to transmit their data to the network. There exist two formats of intra-band CA: (i) contiguous wherein individual carriers (aggregation components) are placed adjacent to one another within the LTE communication band. The resultant aggregated channel may be considered by the UE as a single channel of increased bandwidth compared to individual aggregation components. In some implementations of the intra-band contiguous CA, a single transceiver may be utilized by a given terminal or UE in order to communicate. It is noteworthy that characteristics of a transceiver (e.g., receive filter bandwidth, power amplifier bandwidth and/or other parameters) may need to be configured in accordance with the requirements of the aggregated channel (e.g., increased bandwidth) in order to provide communication without a reduction in performance; (ii) non-contiguous, wherein individual carriers (aggregation components) may be placed non-adjacent (e.g., separated by a frequency gap) to one another within the LTE communication. In some implementations of noncontiguous CA, two transceivers may be required.

Antenna apparatus 200 in FIG. 2A comprises antenna elements 202, 204, 206 coupled to transceiver engine component 210. In some implementations, the antenna elements 202, 204, 206 may be configured to operate in one or more frequency bands, e.g., the bands described above with respect to FIGS. 1A-1B. The transceiver engine component 210 may selectively couple antenna elements 202, 204, 206 via pathways 212, 214, 216 to one or more feed ports of the transceiver electronics. As shown in FIG. 2A, antenna elements 202, 204 may be electrically combined with one another to form a combined (from a radio frequency viewpoint) antenna element 208. In some implementations, combining the antenna elements (e.g., 202, 204) may be effectuated by electrically connecting the feed connection of the respective antenna elements. Ground connections (not shown) may be connected to the ground of the transceiver engine 210 and may remain not switched when changing from one mode of operation to another mode of operation. The combined antenna element 208 is characterized by an increased operational bandwidth comprising a sum of individual bandwidth components 202, 204. Increased bandwidth of the combined antenna element 208 may be used to enable communication at an increased data rate, as compared to communication using individual component (e.g., 202, 204).

In some 2×2 MIMO implementations, the antenna component 206 may be used to provide another receive path that is dependent upon the dimensions allocated to the antennas. For example, assuming the same height and ground clearance for each of the antennas, antenna component 206 would have effectively twice the volume and hence, will cover twice the instantaneous bandwidth as compared with antenna component 202 or 204. By way of an illustration, the combined antenna element 208 may communicate in frequency band 1 providing a transmit path Tx1 and a first receive path Rx11 in frequency band 1. The antenna element 206 may communicate in frequency band 1, thereby providing a second receive path Rx12 in frequency band 1.

FIG. 2B illustrates a multi-element antenna apparatus 220 configured for inter-band CA and/or MIMO communication in accordance with one implementation. Antenna apparatus 220 in FIG. 2B comprises antenna elements 222, 224, 226 coupled to transceiver engine component 230 via pathways 232, 234, 236. In some implementations, the antenna elements 222, 224, 226 may be configured to operate in one or more frequency bands, e.g., the bands described above with respect to FIGS. 1A-1B. The transceiver component 230 may selectively couple antenna elements 222, 224, 226 via pathways 232, 234, 236 to one or more feed ports of the transceiver electronics.

In some implementations of inter-band downlink CA, two antenna elements (e.g., 226 and 222) may be configured to cover two receive channels Rx11, Rx21 (occupying frequency bands 1 and 2, respectively) and a transmit channel in one of the frequency bands 1 or 2: Tx1 or Tx2. Antenna element 224 may be configured to form MIMO Rx path for one of the channels: Rx12 or Rx22. The configuration shown in FIG. 2B may be used to enable higher information rate communication due to increased bandwidth (e.g., combined bandwidths of Rx11, Rx21) and simultaneous MIMO operation (Rx12 or Rx22) as compared to communication rate when communicating over an individual antenna component (e.g., 222 or 226).

FIGS. 3A-3B illustrate use of a multi-element antenna apparatus 300, 320 to mitigate communication interference during hand held operation of a mobile communications device in accordance with one implementation.

Antenna apparatus 300 in FIG. 3A includes antenna elements 302, 304, 306 coupled to transceiver engine component 310. In some implementations, the antenna elements 302, 304, 306 are configured to operate in one or more frequency bands, e.g., the bands described above with respect to FIGS. 1A-1B. The antenna elements 302, 304 may be disposed along a bottom edge of the antenna apparatus 300 corresponding to a lower edge of the mobile communication device (e.g., as shown by elements 502, 504 of the device 512 in FIG. 5). The antenna element 306 in FIG. 3A may be disposed along a top edge of the antenna apparatus 300 corresponding to an upper edge of the mobile communication device (e.g., as shown by component 506 of the device 512 in FIG. 5). The transceiver component 310 in FIG. 3A may selectively couple antenna elements 302, 304, 306 to one or more feed ports of the transceiver electronics.

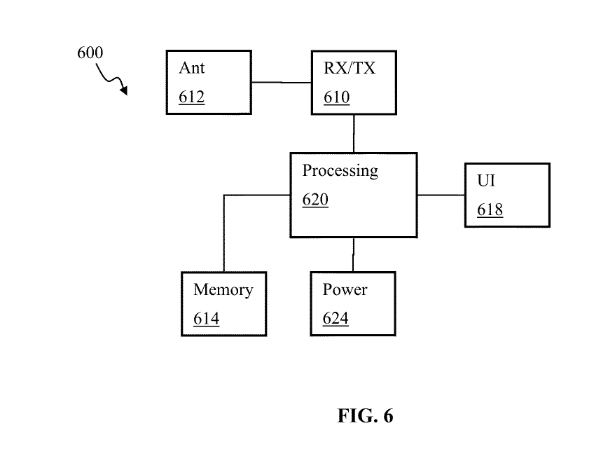

The transceiver component 310 may be coupled to a processing component (e.g., 620 in FIG. 6) configured to determine operational parameters of communication for the antenna apparatus 300. Based on a determination that operation of one of the antenna elements (e.g., 302, 304) has degraded (e.g., as characterized by a reduced received signal strength indication (RSSI)) the transceiver 310 may deactivate communication using antenna element 304 (shown as hashed rectangle in FIG. 3A) and switch communication over to antenna element 306. The performance degradation may be due to proximity of user hand (e.g., 520 in FIG. 5) during hand-held operation of the mobile device.

In some implementation, such as that shown in FIG. 3B, performance of both lower antenna elements (e.g., 322, 324) may become degraded, e.g., during hand held operation. Responsive to a determination that the receive performance of the antenna elements 322, 324 has been diminished, the transceiver 310 may discontinue signal reception via components 322, 324 (as shown by dot-filled rectangles in FIG. 3B) and switch signal reception (e.g., Rx1) over to antenna element 326. Signal transmission Tx1 may be effectuated via one or both antenna elements 322, 324.

FIG. 4 illustrates multi-element antenna apparatus 400 configured to provide SVD communication for a mobile communications device in accordance with one implementation. Antenna apparatus 400 in FIG. 4 comprises antenna elements 402, 404, 406 coupled to transceiver engine component 410. In some implementations, the antenna components 402, 404, 406 may be configured to operate in one or more frequency bands, e.g., the bands described above with respect to FIGS. 1A-1B. The transceiver component 410 may selectively couple antenna elements 402, 404, 406 to one or more feed ports of the transceiver electronics.

In some implementations it may be desirable to enable data communications to occur contemporaneously with voice communication. As used herein, the term voice communication is used to describe communication of information related to voice calls irrespective as to whether the voice calls may be implemented via, for example, IP data transmission mode or circuit-switched mode. By way of illustration, a user may receive a voice call while checking email and/or browsing the Internet. The SVD mode of operation may enable the user to answer the voice call without necessitating disconnection of the data session.

In some implementations of SVD, one or more antenna elements (e.g., 402, and/or 404 and/or 406) may be used to communicate data. Upon detecting a voice call, the transceiver component 410 may configure an unused antenna component (e.g., 404) to effectuate voice call transmissions. In some implementations, wherein all three available antenna elements may be used for one mode of communication (e.g., data) upon detecting a voice call, the transceiver component 410 may be configured to automatically switch over one of the components from the data mode to the voice mode.

FIG. 6 illustrates a mobile communications device 600 for use with a multiband antenna apparatus configured in accordance with one or more implementations described herein. The mobile communications device of FIG. 6 may comprise a user equipment (UE) portable communications device e.g., a smartphone, a phablet, a tablet computing device, a personal digital assistance device, a smartwatch (e.g., comprising a cellular communications component), a personal navigation device, and/or other portable radio communications devices that may benefit from use of the multi-element configurable antenna methodology of the present disclosure.

Device 600 may include a processing component 620 configured to effectuate, inter alia, the performance of one or more functions by the mobile device 600. In some implementations, the processing component 620 may execute computer programs configured to implement one or more communications protocols (e.g., LTE, LTE-A), configure UE for CA operation, detect performance degradation due to user hand operation, cause actuation/deactivation/switchover of one or more antenna elements, implement SVD operation, and/or other functionality. The proceeding component may be implemented as dedicated hardware (e.g., system on a chip), programmable logic (e.g., field programmable gate arrays (FPGAs), and/or other logical components, application specific integrated circuits (ASICs), and/or other machine implementations.

The processing component 620 may interface with a memory component(s) 614, electronics engine component(s) 610, power component(s) 624, and/or user interface component(s) 618 via one or more driver interfaces and/or software abstraction layers. The memory component 614 may comprise read only nonvolatile memory configured to store, e.g., configuration of the device 600 and/or processing code, random access volatile memory configured to enable operation of the processing operations (e.g., store computed parameters and/or variables) and/or read/write nonvolatile memory configured to store user data (e.g., pictures, contacts, and/or other data).

In one or more implementations, the electronics engine 610 may comprise one or more transceivers (Rx/Tx), receivers, that includes one or more feed ports, filters, switches, matching circuits, and/or other components configured to enable RF communication by the device 600 in one or more frequency bands (e.g., UB, MB, LB described above with respect to FIGS. 1A-1B).

Device 600 may include an antenna component 612 comprising one or more antenna elements. In one or more implementations, the antenna component 612 may comprise three or more antenna elements (e.g., 102, 104, 106 described above with respect to FIG. 1A). Antenna component 612 is coupled to the electronics engine 610. In one or more implementations, the antenna component 612 may be configured to support communication in CA, MIMO, SVD modes, switchover to combat interference and/or other modes of communication.

The processing component 620 may interface to UI component 618 in order to detect one or more user inputs (e.g., button presses) and/or display date to user. In some implementations, the UI component may comprise one or more keys/buttons (e.g., keypad, keyboard), and/or a display (e.g., a touch sensitive display), a microphone, a speaker, a camera, and/or other components.

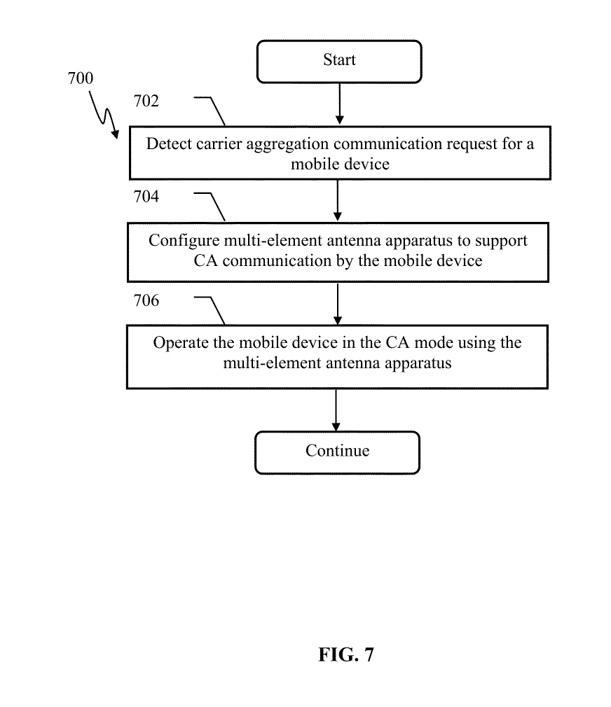

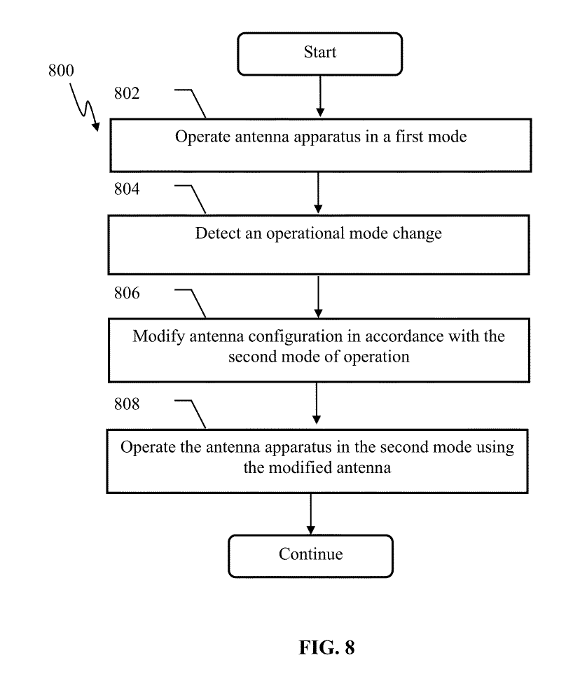

FIGS. 7-8 illustrate methods of operating a multi-element antenna apparatus in accordance with one or more implementations. The operations of methods 700, 800 presented below are intended to be illustrative. In some implementations, methods 700, 800 may be accomplished with one or more additional operations not described, and/or without one or more of the operations discussed. Additionally, the order in which the operations of methods 700, 800 are illustrated in FIGS. 7-8 described below is not intended to be limiting.

Methods 700, 800 may be implemented in one or more processing devices (e.g., a digital processor, an analog processor, a digital circuit designed to process information, an analog circuit designed to process information, a state machine, and/or other mechanism for electronically processing information and/or configured to execute computer program modules stored as computer readable instructions). The one or more processing devices may include one or more devices executing some or all of the operations of methods 700, 800 in response to instructions stored electronically on a non-transitory electronic storage medium. The one or more processing devices may include one or more devices configured through hardware, firmware, and/or software to be specifically designed for execution of one or more of the operations of methods 700, 800. The operations of methods 700, 800 may be implemented by a mobile communications apparatus (e.g., 512 in FIG. 5 and/or 600 in FIG. 6).

Referring now to FIG. 7, a method of using multi-element antenna apparatus for CA operation in mobile communications devices 700 in accordance with one or more implementations is shown.

At step 702, of method 700, CA communication request may be detected at a mobile device. The mobile device may comprise a UE that includes multi-element antenna apparatus described above with respect to FIGS. 1A-4. In some implementations, the CA request may comprise information configured to cause the mobile device communicate using intra-band (contiguous or non-contiguous) CA mode. In some implementations, the CA request may comprise information configured to cause the mobile device to communicate using an inter-band CA mode. In one or more implementations, the CA communications mode may comprise MIMO communications.

At step 704, the multi-element antenna apparatus of the mobile device may be configured to support CA communication by the mobile device. In one or more implementations, the antenna configuration may comprise combining two antenna elements (e.g., 202, 204) to form an electrically larger antenna element with a larger bandwidth. In some implementations, the antenna configuration may comprise configuring two antenna elements (e.g., 224, 226 in FIG. 2B) to support two Rx bands and one Tx bands.

At step 706, the mobile device may be operated in the CA mode using the multi-element antenna apparatus configured at step 704. In some implementations of intra-band CA, communication of operation 706 by the multi-element antenna apparatus of the disclosure may be characterized by data rate that may be greater compared to communication using an antenna comprising, for example, a single antenna element.

FIG. 8 illustrates one embodiment of a method of operating the multi-element antenna apparatus according to the present disclosure. The multi-element antenna apparatus may comprise e.g., antenna apparatus 100 described above with respect to FIG. 1A.

At step 802, antenna apparatus may be operable in a first mode. In one or more implementations, the first mode of operation may comprise any applicable mode of wireless communication (e.g., data only, voice only, SVD, single carrier mode, CA, MIMO, single in single out (SISO)) and/or other modes.

At step 804, an operational mode change may be detected. In some implementations, the mode change may be configured based on a detection of degraded performance (e.g., due to hand held operation), detection of a voice call during a data session, request for higher data rate data session (e.g., due to a user activating a streaming video session), and/or other communication modes.

At step 806, antenna configuration may be modified in accordance with the second mode of operation. In one or more implementations, the configuration modification may comprise configuring the multi element antenna apparatus for CA, CA with MIMO, MIMO to provide for, e.g. a greater bandwidth, and/or reconfiguring antenna elements to combat interference.

At step 808, antenna apparatus may be operated in accordance with the configuration modified at step 806. By way of an illustration, the antenna configuration of step 806 may comprise combining two antenna elements (e.g., 202 and 204) into a single antenna element. Communication of step 808 may comprise intra-band CA mode of operation to provide for an increased data rate, compared to communication using one of the antenna elements (e.g., 202 or 204).

It will be recognized that while certain aspects of the disclosure are described in terms of a specific sequence of steps of a method, these descriptions are only illustrative of the broader methods of the present disclosure, and may be modified as required by the particular application. In some implementations, CA and MIMO communication may be effectuated independent from one another. By way of an illustration, an antenna apparatus 100 may be configured to communicate using MIMO spatial multiplexing without activating the CA mode of communication. In one or more implementations, CA mode of communication may be activated without the MIMO operation. In some implementation, two antenna components (e.g., 102, 104 or 102, 106 in FIG. 1A) may be configured to receive a given communication stream thereby providing path diversity and improving signal reception reliability. Certain steps may be rendered unnecessary or optional under certain circumstances. Additionally, certain steps or functionality may be added to the disclosed embodiments, or the order of performance of two or more steps permuted. All such variations are considered to be encompassed within the disclosure as discussed and claimed herein.

While the above detailed description has shown, described, and pointed out novel features of the present disclosure as applied to various embodiments, it will be understood that various omissions, substitutions, and changes in the form and details of the device or process illustrated may be made by those skilled in the art without departing from the present disclosure. The foregoing description is of the best mode presently contemplated of carrying out the present disclosure. This description is in no way meant to be limiting, but rather should be taken as illustrative of the general principles of the present disclosure. The scope of the present disclosure should be determined with reference to the claims.

What is claimed is:

1. An antenna apparatus, comprising:
a first, a second, and a third radiator elements;
a tuning component configured to tune individual ones of the first, second and third radiator elements operate in a respective frequency band; and
a switching component configured to electrically combine the first and the second antenna radiator elements to produce a combined radiator component;
wherein:
the first and the second antenna radiator elements are configured to operate using a first and a second carrier characterized by first and second bandwidth;
the combined radiator component is configured to perform communication using a third radio frequency carrier characterized by third bandwidth; and
the third bandwidth comprises a sum of the first and the second bandwidths.

2. The antenna apparatus of claim 1, wherein:
the tuning component configured to tune the first and the second radiator elements to operate in a first frequency band; and
the first and the second carrier are configured within the first frequency band.

3. The antenna apparatus of claim 2, wherein
the respective frequency band comprises one of a lower frequency band selected in a range between 600 MHz and 960 MHz and an upper frequency band selected in a range between 1700 MHz and 2700 MHz; and
the first frequency band comprises one of the lower or upper frequency bands.

4. The antenna apparatus of claim 2, wherein
the first bandwidth is configured to occupy a frequency range adjacent to frequency range corresponding to the second bandwidth so that the third bandwidth comprises a contiguous frequency range.

5. The antenna apparatus of claim 2, wherein
the first bandwidth is configured to occupy a frequency range spaced apart from frequency range corresponding to the second bandwidth so that the third bandwidth comprises a frequency range comprising a gap of frequency that is unused by the combined radiator component.

6. The antenna apparatus of claim 1, wherein:
the tuning component configured to tune the first radiator elements to operate in a first frequency band and the second radiator elements to operate in a second frequency band; and
operation of the combined radiator component comprises receiving radio waves in the first frequency band contemporaneous with receiving radio waves in the second frequency band.

7. The antenna apparatus of claim 6, wherein:
the receiving the radio waves in the first frequency band is effectuated by the first radiator element; and
the receiving the radio waves in the second frequency band is effectuated by the second radiator element.

8. The antenna apparatus of claim 6, wherein:
the tuning component configured to tune the third radiator element to operate in one of the first or the second frequency bands, the operation comprising receiving radio waves in the one of the first or the second frequency bands independent of the receiving radio waves by the combined radiator component.

9. A mobile wireless communications device comprising:
a transceiver component;
a multi-element antenna apparatus operably coupled to the transceiver; and
a logic component coupled to the transceiver, the logic component operable to:
detect interference associated with communicating data via a first antenna element of the multi-element antenna apparatus; and
direct the transceiver to switch the communication to a second antenna element of the multi-element antenna apparatus;
wherein:
the first antenna element is configured to transmit and receive data at a first carrier within a frequency band; and
the second antenna element is configured only to receive data at the first carrier.

10. The device of claim 9, wherein the interference determination is configured based on analysis of strength of signal received by the first antenna element at the first carrier.

11. The device of claim 9, wherein the mobile communications device further comprises:
an electronics board comprising the logic component; and
an enclosure housing the electronics board and the transceiver component;
wherein the enclosure is characterized by a rectangular shape comprising a top edge and a bottom edge.

12. The device of claim 11, wherein:
the first and the second antenna elements are disposed proximate the bottom edge; and
the third antenna elements is disposed proximate the top edge, the disposition proximity being configured based on a distance between a most proximate point of a given antenna elements to a respective edge being smaller than lateral extent of the given antenna elements.

13. A method for configuring an antenna apparatus of a mobile wireless device to communicate in a carrier aggregation mode, the method comprising:
configuring a first, a second and a third antenna elements to operate in a first or a second frequency bands, frequencies within the first frequency band being separated from frequencies within the second frequency band by a range of frequencies at least the first bandwidth of the first band;
coupling individual ones of the first, second and third antenna elements to a switching component;
configuring the switching component to electrically combine the first and the second antenna elements to produce a combined component;
wherein:
the first and the second antenna radiator elements are configured to operate using a first and a second carrier characterized by first and second bandwidth;
the combined radiator component is configured to perform communication using a third radio frequency carrier characterized by third bandwidth; and
the third bandwidth comprises a sum of the first and the second bandwidths.

14. The method of claim 13, wherein the act of combining is configured to occur based on a receipt of an indication by the mobile device for operation in a carrier aggregation mode.

15. The method of claim 13, wherein:
the carrier aggregation mode comprises an intra-band carrier aggregation mode configured to place the first and the second carrier into a given band of the first or a second frequency bands.

16. The method of claim 15, wherein:
the intra-band aggregation mode comprises a contiguous carrier aggregation model; and
the first bandwidth is configured to occupy a frequency range adjacent to frequency range corresponding to the second bandwidth so that the third bandwidth comprises a contiguous frequency range.

17. The method of claim 15, wherein:
the intra-band aggregation mode comprises a non-contiguous carrier aggregation model; and
the first bandwidth is configured to occupy a frequency range spaced from frequency range corresponding to the second bandwidth.

18. The method of claim 15, wherein:
the combined antenna component is configured to communicate via first carrier and the second carrier information related to a data session associated with the mobile device; and
the third antenna element is configured to communicate, via a third carrier, information related to a voice session associated with the mobile device, the voice infoithation communication configured to occur contemporaneous with the data information communication.

19. The method of claim 13, wherein intra-band non-contiguous characterized by a gap (unused frequency extent between frequency range of the first bandwidth and frequency range of the second bandwidth.

20. The method of claim 13, wherein:
the first antenna element is configured to operate in the first frequency band;
the second antenna element is configured to operate in the second frequency band, the second frequency band being spaced from the first frequency band by at least half of frequency extent of the first frequency band; and
the carrier aggregation mode comprises an inter-band carrier aggregation mode configured to place the first carrier into one of the first or the second frequency bands and the second carrier into the other one of the first or the second frequency bands.

21. The method of claim 13, wherein:
the first carrier is configured to communicate information related to a data session associated with the mobile device; and
the second carrier is configured to communicate information related to a voice session associated with the mobile device, the voice information communication configured to occur contemporaneous with the data information communication.
